(19) United States
(12) Patent Application Publication
(10) Pub. No.: US 2024/0361227 A1
(43) Pub. Date: Oct. 31, 2024

(54) MODIFIED MICROFLUIDIC IMPEDANCE BASED LAB ON CHIP FOR INDIVIDUAL CELL COUNTING AND A PROCESS FOR FABRICATION THEREOF

(71) Applicants: Pratimesh Labs Pvt. Ltd., New Delhi (IN); Council of Scientific and Industrial Research, New Delhi (IN)

(72) Inventors: Sasikala Subramaniam, Bengaluru (IN); Prasanta Chowdhury, Bengaluru (IN); Usama Abbasi Ahmed, Bengaluru (IN); Prakhar Jain, Bengaluru (IN); Subham Banerjee, Bengaluru (IN)

(21) Appl. No.: 18/770,437

(22) Filed: Jul. 11, 2024

Related U.S. Application Data
(63) Continuation of application No. PCT/IN2019/050478, filed on Jun. 25, 2019.

(30) Foreign Application Priority Data
Apr. 3, 2019 (IN) 201911013440

(51) Int. Cl. G01N 15/12; B01L 3/00; G01N 15/10

(52) U.S. Cl. CPC G01N 15/131; B01L 3/502715; B01L 2300/0645; B01L 2400/0463; G01N 2015/1006; G01N 2015/135

(57) ABSTRACT

Microfluidic impedance based lab on chip is a sensor module to measure the impedance of a single biological cell flowing in channel of micrometer size. In the present invention, the enhancement in the channel cross-section 30 micron [h]×45 micron [w] leads to reduce the pressure drop significantly i.e., around 40 kPa at 100 microliter/min, which demands by cartridge based micro-pump for portable devices at Point of Care (PoC) location. Lab on chip of present invention is capable of withstanding 20 Vpp for several hours without degradation of electrodes and also capable to measure the particle with dimension down to 2 microns. Lab on chip of present invention was also used to count the platelet of the diluted blood samples without any pretreatment and comparable to the clinical lab report.

### RELATED APPLICATIONS

This application claims the benefit under 35 U.S.C. § 120, and is a continuation of, co-pending International Application PCT/IN2019/050478, filed Jun. 25, 2019 and designating the US, which claims priority to IN application No. 201911013440, filed Apr. 3, 2019, such IN Applications also being claimed priority to under 35 U.S.C. § 119. These IN and International applications are incorporated by reference herein in their entireties.

### FIELD

The present invention relates to a modified microfluidic impedance based chip and a process for reducing particle position dependency in its channel. The present invention more particularly relates to the fabrication of a microfluidic impedance lab on chip and measuring the impedance of individual particle across the channel.

### BACKGROUND

Microfluidic impedance lab on chip for cell counting comprises of mainly two components: fluidic channel for receiving the fluid containing the individual particles suspended in the fluid and minimum two pairs of electrodes, where one pair is being used as measurement electrodes and other pair being used as signal electrodes. The fluidic channel is known as microfluidic channel and typically having rectangular cross-section of width and height in the order few tens of microns. Each pair of electrodes for both measurement and signal electrodes are fabricated on top and bottom surfaces of the fluidic channel.

In a Microfluidic lab on chip, the suspended individual particles in the liquid moves with certain velocity in the fluidic channel and crosses gaps between each pair of electrodes aligned vertically to top and bottom surfaces which results in the change of the measured current as differential output and recorded as an impedance signal corresponding to that particle. The amplitude of the impedance signal measured through this apparatus varies as a cube of the particle diameters and other shape effects and through this method, accurate counting of the particles with different diameters suspended in the liquid may be provided.

However, the above mentioned microfluidic lab on chip had several disadvantages. In such chip, the measured impedance signal had different amplitudes when same dimension of particles travel between the electrodes at different height levels with respect to the center of the channel. This in turn leads to the large error in the statistics of the particle dimensions of same size and error in determining the accurate size of particles of different dimension. To overcome this following methods are adopted in existing practice as given below.

Reference may be made to a coulter counter, wherein an aperture with two electrodes is separated by one signal electrode and the other measuring electrode. The particle is pushed inside the aperture which results in change in the current magnitude between measuring and sensing electrode. The change in the current depends on the size of the particle. A coulter apparatus requires a sheath flow for detecting the smaller size particle because of poor sensitivity of the sensor because the two electrodes are separated by more than few millimeters which results in huge wastage of the sheath fluid.

Reference may be made to U.S. Pat. No. 6,437,551, wherein a micro fabricated instrument is disclosed for detecting and identifying cells and other particles based on alternating current (AC) impedance measurements. This micro-fabricated AC impedance sensor includes two critical elements: 1) a microfluidic chip, preferably of glass substrates, having at least one microchannel therein and with electrodes patterned on substrates, and 2) electrical circuits that connect to the electrodes on the microfluidic chip and detect signals associated with particles traveling down the microchannel. The device described here resembles more like coulter counter with single pair of electrode. As there is no reference electrode so the signal is noisy and also not very sensitive for counting smaller particles at lower voltages.

Reference may be made to U.S. patent application No. 20050114041 A1, wherein a method for discrimination of particles is disclosed, and preferably biological cells, in a measurement channel having a liquid for transporting the particles by impedance spectroscopy. Pairs of measurement and reference electrodes are arranged in the measurement channel. During movement of a particle through the pair of measurement electrodes, the pairs of measurement and reference electrodes are admitted with same input signals having different frequencies. Measurement values at the measurement and reference electrodes are compared to determine particle specific values for the particle being moved through the measurement channel. The particle specific values for the different frequencies are normalized to a particle specific basic value at a basic frequency; and then the normalized particle specific values are compared with corresponding values of at least one reference particle at the same different frequencies. The comparison shows changes in the capacitance or in the conductance of the particle, which are used in discriminating the particle. As this invention uses two pair of electrode, signal amplitude of the particle depends on the position of particle inside the microfluidic channel. To overcome this, invention has used multi-frequencies for differentiating the capacitance of particle of same size.

Reference may be made to work of Berkel et. al. (Lab-on-chip-2011, 11, 1249), that describes the measurement of platelet and RBC from diluted whole blood using two pairs of electrodes. The two pairs of electrodes on top and bottom wall of the microfluidic channel is better than the coulter aperture because the sensitivity is much improved due to the constricted electric field between top and bottom electrodes with the direction of electric field perpendicular to the velocity of the particle. However, the disadvantage of two pairs of electrodes is that the impedance signal of the particle is dependent on the position of the particle in the Z-direction by 116%. Due to large size difference between the RBC (6-8 micron) and Platelet (2-3 micron), the invention could differentiate the particles, however to distinguish the platelet, they have used asymmetric Gaussian fit due to low SNR values.

Reference may be made to U.S. patent application No. 20160041080A1, wherein a method is disclosed to measure the impedance of individual particle flowing thorough a microfluidic channel. The microfluidic channel in this invention uses 5 pair of electrodes with two signal electrodes, two measurement electrodes and three ground pairs of electrodes between the measurement and the signal electrodes. The presence of extra three pairs of ground electrodes reduces the particle position dependency on the signal amplitude room from 116% to 21%, which still leads to larger coefficient of variation (CV) of 6 for 3 micron particle. For further reduction of CV to 1.53, the measured waveform originated from individual particle was compared with the simulated signal obtained by solving Maxwell equation for each size of particle at different position. The other method described in this patent for correcting the position of particle is by finding the secondary and primary peak from the measured data. The algorithm works well for 3 micron particle having CV of 1.77, but is limited when the size of the particle is less than 3 micron. This algorithm needs huge computation calculation which limits its use in point of care (PoC) applications.

The CV in the size of the particle obtained with optics by measuring the forward scattering using sheath flow reported by Zang et al is more than 20% which is much more compared to the manufacture's CV. (Miniaturization for Chemistry, Biology and Bioengineering, 2004). The best CV obtained using optics and hydrodynamic focusing reported is by Xiaolo Mao et al is more than 9% (Biomicrofluidics, 2012).

### SUMMARY

Considering the limitations of the prior-art documents as stated above, present invention is provided to reduce the particle position dependency while they are flowing through the channels. Modified microfluidic impedance based lab on chip of present invention is consisting of fluidic channel with inlet and outlet ports for receiving and discharging the liquid, said fluidic channel being provided with three pairs of electrodes each functioning as measurement electrodes, signal electrodes and ground electrodes, wherein ground electrodes are placed in the middle of measurement and signal electrodes for reducing the cross current effects while counting cells passing through said channel.

The main objective of the present invention is to develop microfluidic lab on chip for the direct assessment of the shape of the particle suspended in the liquid.

Another objective of the present invention is to design, simulate and fabricate the microfluidic lab on chip which reduces particle position dependency in the measured electrical signal.

Another objective of the present invention is to provide microfluidic lab on chip, where the electrodes are kept far apart to reduce the cross-current effect between the electrodes.

Another objective of the present invention is to provide microfluidic lab on chip where the cross section area of the channel in the sensing region was maintained to reduce the possibility of blockage by the incoming individual particles suspended in the liquid and sufficiently low pressure drop across the inlet to outlet ports.

Yet another objective of the present invention is to provide microfluidic lab on chip, where individual particle generates a complete waveform across the measurement electrodes, while passing through the fluidic channel and subjected under applied electrical signal across the signal electrodes.

Yet another objective of the present invention is to provide cost effective microfluidic lab on chip to assess the particle shape with measuring the simple peak to peak magnitude of the complete waveform generated by the particle.

The present invention relates to a modified microfluidic impedance based chip and a process for reducing particle position dependency in its channel. Accordingly, modified Microfluidic Impedance based Lab on Chip is consisting of 3 pairs of electrodes (1) fabricated on non-conducting bottom and top surface of chip (2 & 3); said electrodes (1) being provided with connecting means (4) for their functioning as measurement (5 & 6), signal (7 & 8) and ground electrodes (9 & 10); said bottom surface of chip (2) being provided with coating of adhesive layer (11) for fluidic channel fabrication (12); said top surface of chip (3) being provided with inlet (13) and outlet port (14) for receiving and discharging the fluid (15) from the said channel (12). The invention is characterized by provision for a pair ground electrode (9 & 10) placed between measurement and (5 & 6) signal electrodes (7 & 8) and provision for a photoimageable adhesive layer (11) on bottom surface (2) for channel fabrication and for bonding between top and bottom surface (2 & 3) of said chip.

### BRIEF DESCRIPTION OF THE DRAWINGS

FIG. 1 shows a typical microfluidic impedance cytometry available in the prior-art domain of the present invention.

FIG. 2 shows a cross-sectional view of the microfluidic impedance lab on chip of the present invention.

FIG. 3 shows the simulated impedance signals generated by an individual particle of diameter 5 micron while flowing through the electrodes shown in FIG. 1 at the distance of z=7, with respect to the central plane (z=0) of the fluidic channel.

FIG. 4 shows the simulated impedance signals generated by an individual particle of diameter 5 micron while flowing through the electrodes shown in FIG. 2 at the distance of z=7, with respect to the central plane (z=0) of the fluidic channel.

FIG. 5 shows the simulated impedance signals generated by an individual particle of diameter 5 micron while flowing through the electrodes shown in FIG. 2 at different vertical locations, z, with respect to the central plane (z=0) of the fluidic channel.

FIG. 6 shows an experimentally measured signal, while an individual particle of diameter 5 micron passes through the fluidic channel close to the electrodes (z=7) and the simulated data corresponding to a particle of same dimension under identical condition.

FIG. 7 shows a histogram chart which presents the count of the particles of diameter 5 micron suspended in the liquid as a function of cube root of impedance of the measured peak amplitude without any signal processing algorithm.

FIG. 8 shows an obtained mixed signal from the individual particles of diameter of 3, 4 and 5 microns suspended in liquid and passing in the fluidic channel.

FIG. 9 shows a histogram chart which presents the count of particles of diameter 3, 4 and 5 microns suspended in the liquid as a function of cube root of impedance of the measured peak amplitude without any signal processing algorithm.

FIG. 10 shows impedance signals generated from particle having diameter 3 micron suspended in liquid and passing in the fluidic channel. Expected signal amplitude from 2 micron particle is shown in this figure.

FIG. 11 shows a measured impedance signal generated from a diluted human blood which predominantly contains platelets and RBC.

FIG. 12 shows a histogram chart which presents the count of platelets and RBC as a function of the cube root of the impedance of signal amplitude.

FIG. 13 shows the raw signal generated by an individual platelet versus fitted Fourier series expansion.

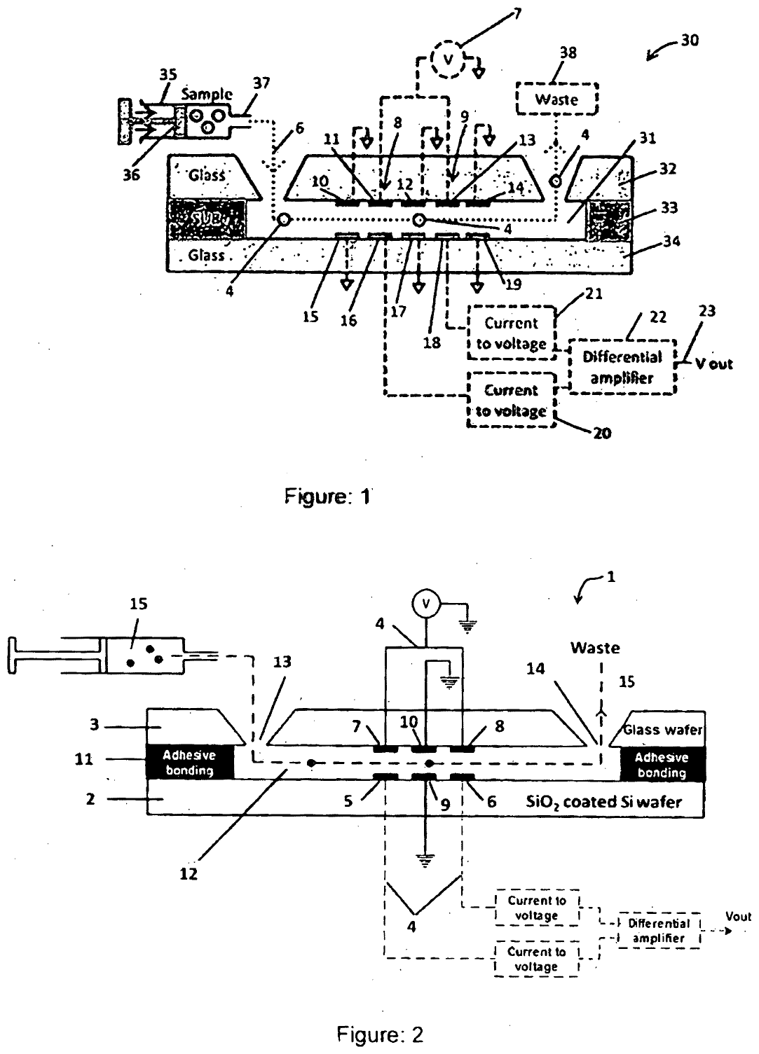

### DETAILED DESCRIPTION

The present invention relates to a modified microfluidic impedance based chip and a process for reducing particle position dependency in its channel. The present invention provides modified microfluidic lab on chip comprising of 3 pairs of microelectrodes (1) fabricated on SiCE coated Si wafer (2) and glass wafer (3), coating of photoimageable adhesive layer (11) on said electrode patterned for fluidic channel (12) fabrication, hole etching on glass wafer for inlet (13) and outlet ports (14), aligning and bonding the top of said electrode patterned (7, 8 & 10) and hole etched glass wafer (3) with bottom Sio₂ coated Si wafer (2) containing electrode patterned (5, 6 & 9), adhesive layer (11) with fluidic channel (12) and dicing of the said bonded wafers for obtaining a single chip.

The ground electrodes (9 & 10) are kept in order to minimize the flow of cross current into the measurement electrodes (5 & 6) & signal electrodes (7 & 8). The magnitude of the cross current depends on the separation between the measurement electrode and the ground electrode and also on the position of the particle in the z direction. The magnitude of the secondary peak obtained is proportional to amount of cross current flowing into the electrodes. The particle closer to the electrode will give higher secondary peak. In the present invention the separation of the ground electrode and the measurement electrode is kept greater than 30 micron to minimize the position dependency of particle. The CV obtained by this geometry is less than 3% without implementing any complex algorithm needed for position correction of particle.

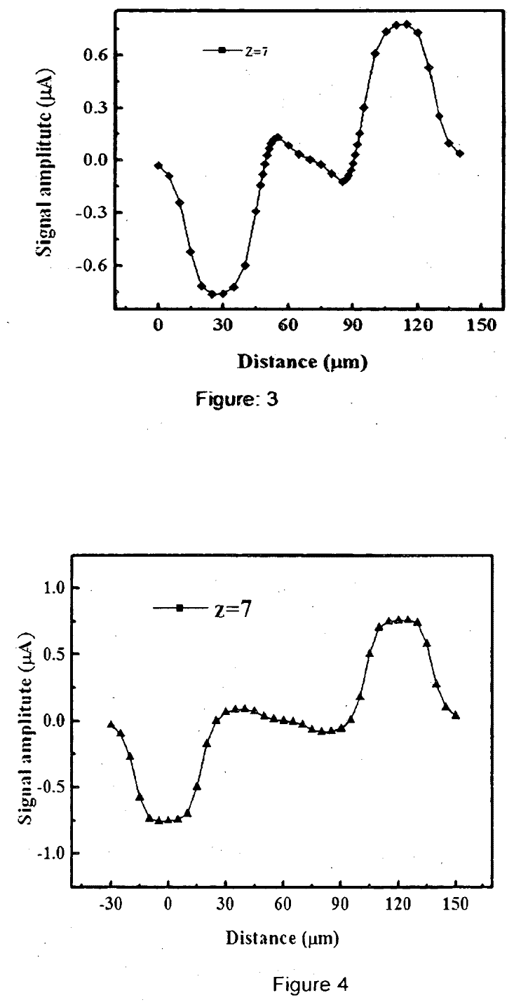

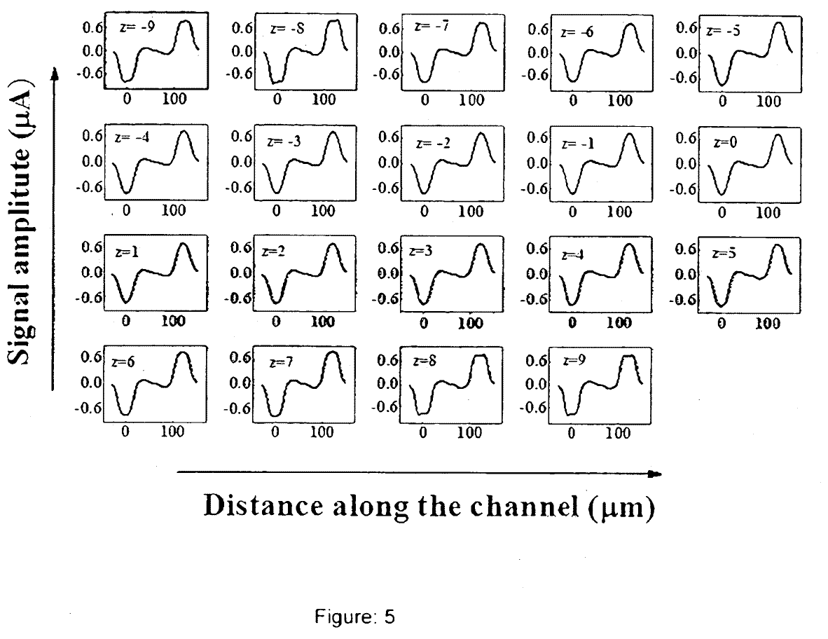

In one embodiment of the present invention, the lab on chip containing three pair of electrodes, where three electrodes (7, 8 &10) are fabricated on the top surface (3) of chip and another three (5, 6 & 9) on bottom surface of chip (2). Two extreme ended electrodes either on top or bottom surface was treated as either signal or measurements electrodes. The middle electrodes both on top and bottom surface were kept as ground electrode (9 & 10). Simulations were carried out keeping electrode edge to edge separations of 10 micron (prior art) and 30 micron (present invention) and the feature of the signal amplitudes for two different electrode separations are shown in FIGS. 3 & 4 for a particle of diameter 5 micron flowing at a distance of z=7 micron (close to the electrodes) form the center plane. As compared these two figures, a pronounced secondary peak was observed for electrode spacing of 10 microns due to greater magnitude of the cross current between the electrodes at lower separations.

FIG. 5 shows the simulated signal with 30 micron spacing electrode with z-spacing from +9 to −9 micron from center plane (z=0). This data clearly indicates an amplitude variation of 15%, which corresponds to diameter variation of 2.2% with 30 micron spacing as the magnitude of the signal is proportional to the cube of the diameter of particle.

In another embodiment of the present invention, an apparatus comprises an electrode arrangement having a pair of measurement electrodes (5 & 6) and a pair of signal electrode (7 & 8). AC voltage (20 Vpp) is applied to the top two signal electrodes and the differential current generated across the bottom two measurement electrodes is measured. Measured particle was passed through the channel as a waste (15) to the outlet. The measured signal was recorded using an in-house developed lock-in amplifier and the data was acquired into computer through ethernet cable. The sampling of the data was carried out at 250 ksps. The low-pass filter cut-off frequency for the lock-in depends on the velocity of the particle and the spacing between either supply/measurements electrodes. The maximum velocity of a cell was calculated from the fluid flow rate and then Fourier series was fitted to a peak in order to calculate the least cut-off frequency needed for demodulation of the signal without suppressing the amplitude of the signal. The post processing of the signal was done in MATLAB for finding signal amplitude.

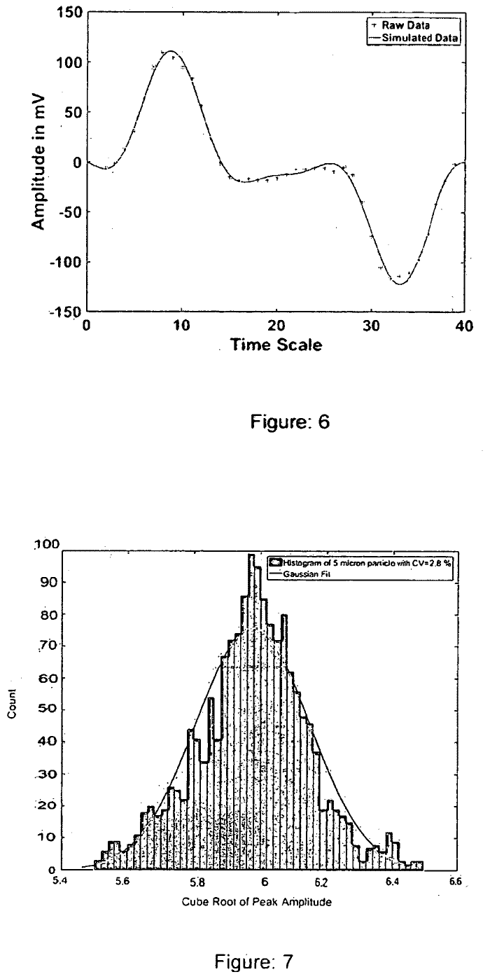

FIG. 6 presents a measured signal from a particle of diameter 5 micron close to the electrode of the fluidic channel along with their the best-fit simulated signal from FIG. 5. FIG. 7 presents the corresponding histogram of the cube root of the impedance of 5 micron diameter particle. The histogram clearly follows the Gaussian distribution and measured co-efficient of variation obtained was around 2.8%. This value is very close to theoretical simulated value of co-efficient of variation of the order of 2.2% and also very close to the manufacture data as provided in Table 1 (a). The present invention also improved CV by two times while compared with 10 and 30 microns spacing. Similarly for other particles of sizes such as 4 and 3 microns, the data are provided in Table 1 (b) and 1 (c), which clearly indicate the improved CV of present invention.

TABLE 1(a)

| | Manufacture's data | | | Experimental data | | | Theoretical data | | |
|---|---|---|---|---|---|---|---|---|---|
| | | Std. | CV | | Std. | CV | | Std. | CV |
| Dia. 5 μm | Mean | dev | % | Mean | dev | % | Mean | dev | % |
| l0 μm | 5 | 0.1 | 2.0 | 5 | 0.3 | 6 | 5 | 0.25 | 5 |
| spacing | | | | | | | | | |
| 30 μm | 5 | 0.1 | 2.0 | 5 | 0.14 | 2.8 | 5 | 0.15 | 3 |
| spacing | | | | | | | | | |

TABLE 1(b)

| | Manufacture's data | | | Experimental data | | | Theoretical data | | |
|---|---|---|---|---|---|---|---|---|---|
| | | Std. | CV | | Std. | CV | | Std. | CV |
| Dia. 4 μm | Mean | dev | % | Mean | dev | % | Mean | dev | % |
| 10 μm | 4 | 0.08 | 2.0 | 4 | 0.252 | 6.3 | 4 | 0.25 | 5 |
| spacing | | | | | | | | | |
| 30 μm | 4 | 0.08 | 2.0 | 4 | 0.124 | 3.1 | 4 | 0.12 | 3 |
| spacing | | | | | | | | | |

TABLE 1(c)

| | Manufacture's data | | | Experimental data | | | Theoretical data | | |
|---|---|---|---|---|---|---|---|---|---|
| | | Std. | CV | | Std. | CV | | Std. | CV |
| Dia. 3 μm | Mean | dev | % | Mean | dev | % | Mean | dev | % |
| 10 μm | 3 | 0.12 | 4.0 | 3 | 0.24 | 8 | 3 | 0.25 | 5 |
| spacing | | | | | | | | | |
| 30 μm | 3 | 0.12 | 4.0 | 3 | 0.132 | 4.4 | 3 | 0.09 | 3 |
| spacing | | | | | | | | | |

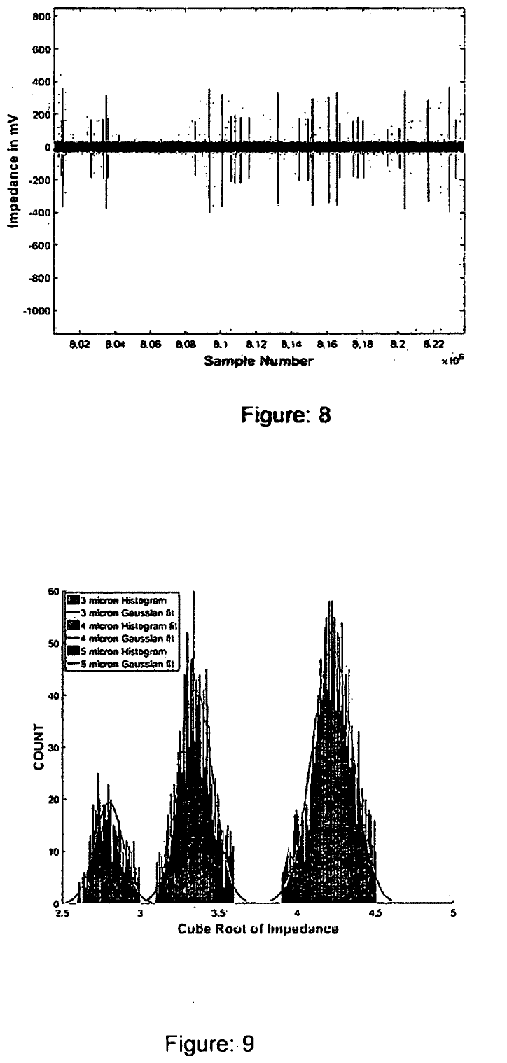

FIG. 8 presents a measured signal from a sample containing mixed particles of diameter 3, 4 and 5 microns.

FIG. 9 shows a histogram of the cube root of the impedance of individual particles of different sizes after counting from primary peak amplitudes. The results of co efficient variation are tabulated in Table 2 along with the data from company data sheet. This clearly indicates that CV is matching quite well with the manufacturing datasheet. The three different histograms shown in FIG. 9 clearly show that the solution which has mixed size of particle can be identified without any need of position correction algorithm and also there is no requirement for hydrodynamic focusing. The 95% confidence limit interval for 3, 4 and 5 micron particle is 3±0.0.5, 4±0.0.28, 5±0.30 respectively.

TABLE 2

| | Manufacture's data | | | Experimental data | | | Theoretical data | | |
|---|---|---|---|---|---|---|---|---|---|
| | | Std. | CV | | Std. | CV | | Std. | CV |
| | Mean | dev | % | Mean | dev | % | Mean | dev | % |
| 30 μm | 3 | 0.12 | 4.0 | 3 | 0.24 | 4.6 | 3 | 0.09 | 3 |
| spacing | | | | | | | | | |
| 30 μm | 4 | 0.08 | 2.0 | 4 | 0.132 | 3.2 | 4 | 0.12 | 3 |
| spacing | | | | | | | | | |
| 30 μm | 5 | 0.1 | 2.0 | 5 | 0.165 | 3.3 | 5 | 0.15 | 3 |
| spacing | | | | | | | | | |

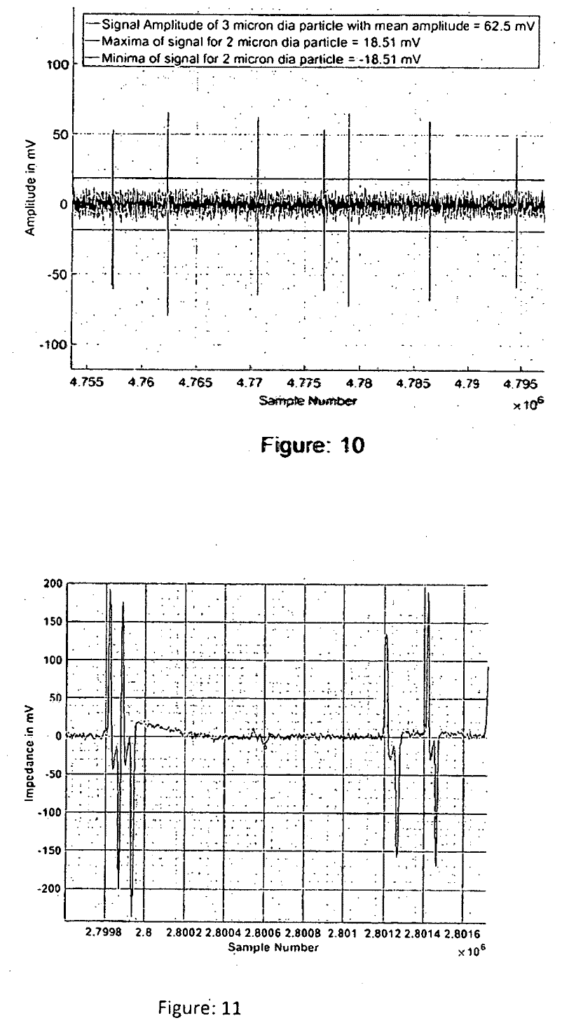

FIG. 10 presents a measured signals from a sample containing particles of diameter 3 microns. The system noise should be less than the impedance signal of the smallest particle. In order to ensure the microfluidic impedance cytometry senses 2 micron particle, the 3 micron particle was pushed into the sensor. The signal amplitude of 3 micron particle is shown in FIG. 10. Since the amplitude varies as the cube of the size of the particle therefore the 2 micron signal should be 3.375 times less compared to 3 micron signal. The black line in FIG. 10 shows clearly that the noise level is half of the impedance signal value due to 2 micron particle. The size of the particle can be determined either with optics by measuring the amount of scattering or impedance but the advantage of sensing the impedance inside the microfluidic over the optics is that the size dependency of the particle on the position of the particle is much reduced while in case of optics for determining the accurate size of particle there is need of hydrodynamic focusing where the sample is squeezed between the sheath fluid. To constrain the particle at particular position three dimension hydrodynamic focusing is required which adds complexity to the instrument and also results in huge wastage of fluid.

In an present invention, a Microfluidic chip with reduced particle position dependency in the channel comprising at least three pairs of electrodes fabricated on non-conducting bottom and top surface of chip (2 &3); said electrodes (1) being provided with connecting means (4) for functioning as measurement electrodes (5 & 6), signal electrodes (7 & 8) and ground electrodes (9 & 10) wherein the ground electrodes are placed in the middle of measurement and signal electrodes with spacing between the measurement and ground electrode greater than 30 micron.

In an embodiment, photoimageable adhesive layer (11) is provided on bottom surface (2) for fabricating a channel of height between 25-32 micron for bonding between top and bottom surface (2 & 3).

In an embodiment, channel has a venturi cross-section having the sensing region located in the throat part of venturi.

In an embodiment, the bottom surface of chip is made of non-conducting material preferably silicon dioxide or silicon nitride coated Silicon wafer.

In an embodiment, the top surface of chip is made of transparent non conducting material preferably glass wafer.

In an embodiment, the channel has height of 27-32 micron and is patterned on adhesive layer of bottom surface.

In an embodiment, the electrodes are made of multilayered stack of tantalum, chromium, platinum and gold.

In an embodiment, electrodes on bottom surface are made of multilayer stack of tantalum, platinum and gold having individual layer thickness of 20 nm, 150 nm and 50 nm respectively.

In an embodiment, the electrodes on top surface are made of multilayer stack of chromium, platinum and gold having individual thickness of 50 nanometer, 150 nanometer and 50 nanometer respectively.

A process for reducing the particle position dependency to a coefficient of variation (CV) less than 3% in the channel of a microfluidic chip, the process comprising:
providing wherein top and bottom surfaces of the microfluidic chip with at least three pairs of electrodes (4, 6, 7, 8, 9, 10);
wherein the ground electrodes (9 and 10) are placed in the middle of the measurement electrodes (5 and 6) and signal electrodes (7 and 8); and spacing between the measurement electrodes and the ground electrodes is greater than 30 micron.

In an embodiment, wherein the microfluidic channel with photoimageable, biocompatible and chemical resist adhesives are fabricated at low temperature (<120° C.) and at low pressure (<100 N).

In an embodiment, the height and width of the fluidic channel is optimized to reduce the blockage by the suspended clustered-particle and to reduce the particle velocity inside the higher cross section of the channel.

In an embodiment, the density of the suspended particles is matched to the density of the solution from 1000 to 1050 kg/m3. The conductivity of the solution is from 0.5 S/m to 2 S/m and flow rate is from 5 microliter/minute to 300 microliter/minute.

In an embodiment, the width of venturi cross section channel containing sensing region is kept at as low as 40-50 micron to lower down the pressure drop by the incoming individual particles suspended therein.

In an embodiment, electrodes are formed on top and bottom surface of chip by liftoff process using UV photolithography technique.

In an embodiment, multilayer stack for electrodes is formed by sputter deposition process.

The following are examples given by way of illustrations, and therefore should not be construed to limit the scope of the present investigation.

### Example 1

In present invention, micro fluidic channel for flowing particle suspended in the liquid is fabricated using the steps of:
1. Coating of photo-imagable adhesive (Perminex 2015, Micro-chemical UK) on microelectrode patterned wafer Sio₂ coated Si wafer using a spin coater. RPM of the spin coater was varied from 1500 to 2000 to obtain the desired layer thickness in the range from 25 to 32 micrometer.
2. Adhesive coated wafer exposed to hot plate during prebaking at a temperature of 95° C. for a duration of 5-7 min.
3. The prebaked wafer was then exposed to UV light under mask to have the desired channel pattern.
4. Then transferring the exposed wafer on the hot plate post bake at temperature 70° C. for 10 to 30 sec.
5. Developing the post baked wafer to have desired channel pattern of adhesive layer on microelectrode patterned Sio₂ coated Si wafer.
6. After development, the channel width was measured around 45 to 50 micrometers and height was measured around 27 to 30 micrometers.

### Example 2

Experimental data from 3 and 5 micron individual beads and signals from 3, 4 and 5 microns mixed beads.

As shown in FIG. 2, the apparatus comprises a fluidic channel for receiving an individual particle suspended in the liquid. In an embodiment of the present invention, polystyrene beads with diameters of 2-5 micrometer (Sigma-Aldrich and Polysciences, 10%) were used as a test measurement and it was diluted and suspended to a concentration of approximately 500 beads/microlitre in PBS containing 0.1% tween 20 and sufficient sucrose to match the density of the suspending medium to the density of the particles (1050 kg/m3). The conductivity of the solution is 1.1 S/m. Particles were pumped to the device with a syringe pump at a flow rate of 10 to 40 microlitre/minute.

### Example 3

Test of diluted human blood for platelet counts and RBC

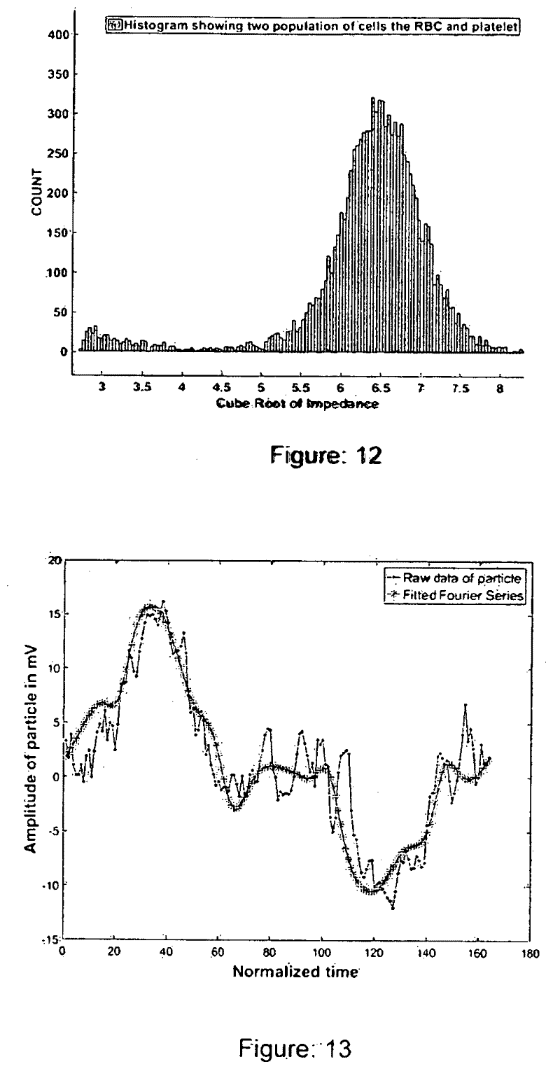

Lab on chip of present invention is also used for full blood count for human beings. FIG. 11 show the impedance of RBC and platelets were measured using the method described in FIG. 2. A histogram of the impedance of the cells is presented and it is evident from the FIG. 12 that the two populations are far separated from each other. To ensure that there is no faulty signal due to the smaller size particle the impedance signal is co-related with the template curve which may be antisymmetric Gaussian fit or a Fourier fit shown in FIG. 13. The signal is faulty if the co-relation is less than 90%.

The method of the present invention enables simple microfluidic impedance analyses to operate without sheath flow particle positioning. The method of present invention is capable of performing multi frequency analysis and it can process small volumes, operate continuously without a need of pre-processing. In present invention, applied signal voltage can be varied from 10 V to 24 V peak to Peak without degrading the electrodes. As the measurement signal is proportional to the applied voltage in present invention, a better signal to Noise ratio (SNR) can be obtained even in higher dimension without compromising the quality of the SNR. Optimizing the height and width of the fluidic channel to reduce the blockage by the suspended clogged particle. Use of a photoimageable, biocompatible, and chemical resist adhesive to fabricate the channel with reduced steps. Operation of process at low temperature (<120° C.) and at low pressure (<100N).

1. A microfluidic chip with reduced particle position dependency in a channel comprising:
at least three pairs of electrodes (4, 6, 7, 8, 9, 10) fabricated on non-conducting bottom and top surface of the chip (2 and 3);
connecting means (4) for connecting measurement electrodes (5 and 6), signal electrodes (7 and 8) and ground electrodes (9 and 10);
wherein the ground electrodes (9 and 10) are placed in the middle of the measurement electrodes (5 and 6) and the signal electrodes (7 and 8); and spacing between the measurement electrodes and the ground electrodes is greater than 30 micron.

2. The microfluidic chip as claimed in claim 1, wherein a photoimageable adhesive layer (11) is provided on the bottom surface (2) for fabricating a channel of height between 25-32 micron for bonding between top and bottom surface (2 and 3).

3. The microfluidic chip as claimed in claim 1, wherein the channel has a venturi cross-section having a sensing region located in throat part of the venturi.

4. The microfluidic chip as claimed in claim 1, wherein the bottom surface of the chip is made of a non-conducting material; wherein the non-conducting material is silicon dioxide or silicon nitride coated silicon wafer.

5. The microfluidic chip as claimed in claim 1, wherein the top surface of the chip is made of a transparent non-conducting material; wherein the transparent non-conducting material is glass wafer.

6. The microfluidic chip as claimed in claim 1, wherein the channel has a height of 27-32 micron and is patterned on adhesive layer of the bottom surface.

7. The microfluidic chip as claimed in claim 1, wherein the electrodes are made of multilayered stack of tantalum, chromium, platinum and gold.

8. The microfluidic chip as claimed in claim 1, wherein the electrodes on the bottom surface are made of multilayer stack of tantalum, platinum and gold having individual layer thickness of 20 nm, 150 nm and 50 nm respectively.

9. The microfluidic chip as claimed in claim 1, wherein the electrodes on the top surface are made of multilayer stack of chromium, platinum and gold having individual layer thickness of 50 nanometer, 150 nanometer and 50 nanometer respectively.

10. A process for reducing particle position dependency to a coefficient of variation (CV) less than 3% in a microfluidic channel of a microfluidic chip, the process comprising:
providing top and bottom surfaces of the microfluidic chip with at least three pairs of electrodes (4, 6, 7, 8, 9, 10);
wherein the ground electrodes (9 and 10) are placed in the middle of the measurement electrodes (5 and 6) and signal electrodes (7 and 8); and spacing between the measurement electrodes and the ground electrodes is greater than 30 micron.

11. The process for reducing the particle position dependency as claimed in claim 10, wherein the microfluidic channel with photoimageable, biocompatible and chemical resist adhesives is fabricated at low temperature (<120° C.) and at low pressure (<100N).

12. The process for reducing the particle position dependency as claimed in claim 10, wherein height and width of the microfluidic channel is optimized to reduce blockage by suspended clustered-particles and to reduce particle velocity inside higher cross section of said channel.

13. The process for reducing the particle position dependency as claimed in claim 10, wherein density of the suspended particles is matched to the density of a solution from 1000 to 1050 kg/m3; wherein conductivity of the solution is from 0.5 S/m to 2 S/m and flow rate is from 5 microliter/minute to 300 microliter/minute.

14. The process for reducing the particle position dependency as claimed in claim 10, wherein width of the venturi-cross-section channel containing sensing region is kept at as low as 40-50 micron to lower down pressure drop by incoming individual particles suspended therein.

15. The process for reducing the particle position dependency as claimed in claim 10, wherein the electrodes are formed on the top and the bottom surfaces of chip by liftoff process using UV photolithography technique.

16. The process for reducing the particle position dependency as claimed in claim 10, wherein multilayer stack for electrodes is formed by sputter deposition process.
